(19) United States
(12) Patent Application Publication
(10) Pub. No.: US 2018/0121293 A1
(43) Pub. Date: May 3, 2018

(54) CODE BASE SYNCHRONIZATION BETWEEN SOURCE CONTROL SYSTEMS

(71) Applicant: Microsoft Technology Licensing, LLC, Redmond, WA (US)

(72) Inventors: Ryan Patrick Phillips, Bellevue, WA (US); Michael Ronn Marcelais, Redmond, WA (US); James Coryell Hilke, Redmond, WA (US); Alexander Whitmore Halfpenny, Seattle, WA (US); Roman Tsegelskyi, Kyiv (UA)

(73) Assignee: Microsoft Technology Licensing, LLC, Redmond, WA (US)

(21) Appl. No.: 15/343,028

(22) Filed: Nov. 3, 2016

(51) Int. Cl. G06F 11/14; G06F 9/44; G06F 17/30

(52) U.S. Cl. CPC G06F 11/1451; G06F 2201/84; G06F 17/30578; G06F 8/36

(57) ABSTRACT

Synchronizing a code base between source control systems is provided. A synchronization engine provides: forward bridging, where source code is migrated from a first source control system to a second source control system; pull bridging, where source code is migrated from the second source control system to the first source control system; and reverse bridging, where source code is merged from the second source control system to the main branch of source code in the first source control system.

### BACKGROUND

When building a particular software system, application, or software component, software developers continually write new source code or change existing source code. Source control systems are used to manage changes to source code over time, and can include centralized or distributed source control systems. For example, a source control system allows for reverting files back to a previous state, reverting an entire project back to a previous state, comparing changes over time, seeing who may have introduced an issue and when, etc.

A centralized source control system permits revision control from a centralized location, typically based on a client/server model. For example, in a centralized source control system, a source code repository may be maintained on one or more servers. A software developer on a client computing device may check out source code from the source code repository, and check in source code to the source code repository after changes are made.

A distributed source control system provides revision control on a peer-to-peer model. For example, in a distributed source control system, each peer's working copy of the source code is a complete source code repository. A distributed source control system may or may not include a central repository on which client computing devices synchronize.

A software development company may decide to transition from using one type of source control system to another (e.g., transition from using a centralized source control system to a distributed source control system, transition from using a distributed source control system to a centralized source control system, transition from using one centralized source control system to another centralized source control system, or transition from using one distributed source control system to another distributed source control system). As can be appreciated, the company may have a large investment in its current source control system for building, testing, and deploying, and may find it difficult to migrate all existing tools that rely on the current source control system to a new source control system at once or within a short time frame. However, the company may still wish to continue to develop software while transitioning from one system to another. For example, during a source control system transition, software developers may want to use a distributed source control system, but may also need to check their source code into their company's centralized source control system without causing merge conflicts, which oftentimes require manual intervention.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects are directed to an automated system, method, and computer storage medium for transferring and synchronizing code between different source control systems. The synchronization engine provides: forward bridging, where source code is migrated from a first source control system to a second source control system; pull bridging, where source code is migrated from the second source control system to the first source control system; and reverse bridging, where source code is merged from the second source control system to the main branch of source code in the first source control system.

In one example use case, a synchronization engine may be used to help mitigate the migration path from using one source control system to another source control system. For example, the synchronization engine enables developers to use two different source control systems to make changes to a source code base. The transfer and synchronization of code between different source control systems provided by the synchronization engine improves computer efficiency by reconciling changes made to the source code in either source control system without automatically causing merge conflicts. For example, merge conflicts oftentimes require manual intervention by a developer to resolve, and require additional processing by the computing device.

Examples are implemented as a computer process, a computing system, or as an article of manufacture such as a device, computer program product, or computer readable medium. According to an aspect, the computer program product is a computer storage medium readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram of an example operating environment including a synchronization engine for synchronizing a code base between source control systems;

FIG. 2 is a data flow diagram showing an example of a forward bridging process migrating source code from a centralized source control system to a distributed source control system;

FIG. 3 is a data flow diagram showing an example of a pull bridging process migrating source code from a distributed source control system to a centralized source control system;

FIG. 4 is a data flow diagram showing an example reverse bridging process merging source code from a distributed source control system to a main branch of source code in a centralized source control system;

FIG. 5 is a flow chart showing general stages involved in an example method for migrating source code between source control systems;

FIG. 6 is a block diagram illustrating example physical components of a computing device;

FIGS. 7A and 7B are simplified block diagrams of a mobile computing device; and

FIG. 8 is a simplified block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to a method, system, and computer storage medium for transferring and synchronizing code between different source control systems. For example, a software developer may want to use a one source control system to make changes to source code managed by another source control system. To enable an efficient migration of the source code between the source control systems without causing automatic merge conflicts when changes have been made, a synchronization engine creates a bridge for providing: forward bridging, where source code is migrated from a first source control system to a second source control system; pull bridging, where source code is migrated from the second source control system to the first source control system; and reverse bridging, where source code is merged from the second source control system to the main branch of source code in the first source control system.

Using the method, system, and computer storage medium, a replica of a first source code repository or a subset of a source code repository is received from a first source control system, and stored in a staging directory. For example, the replica of the first source code repository or the subset of the source code repository corresponds to a software development project on which a developer or user is working. The replicated first source code is overlaid on top of a local repository comprising a second source code managed by a second source control system, and is synchronized. The differences of the source code files are moved to a temporary branch, which are merged from the temporary branch to a master branch of the second source control system.

Changes may then be made to the source code in the second source control system. Upon receiving an indication of a commit to the master branch, the synchronization engine pulls the changes into a local repository associated with the second source control system, and overlays a repository associated with the first source control system over the local repository associated with the second source control system. The source code files are synchronized, and differences between the source code files are identified and stored in a change set. Further, the synchronization engine checks the change set into the first source control system, where a validation loop validates that the change can build. To complete the loop, a baseless merge is performed between the source code files in the change set and a main branch of the first source code managed by the first source control system.

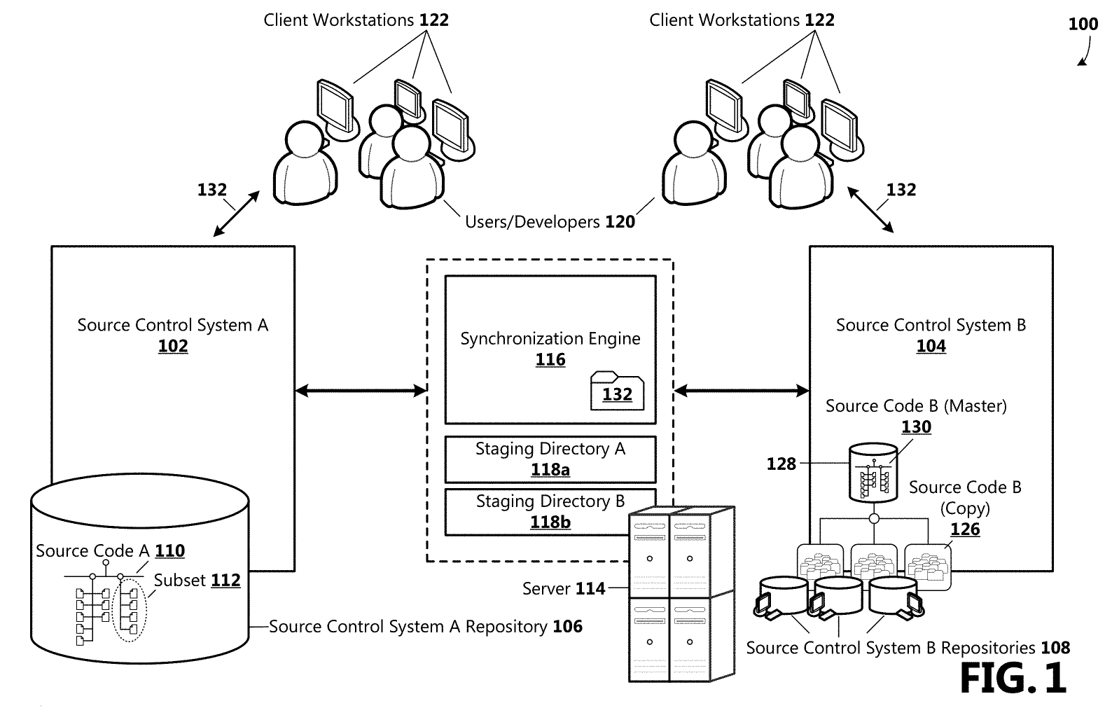

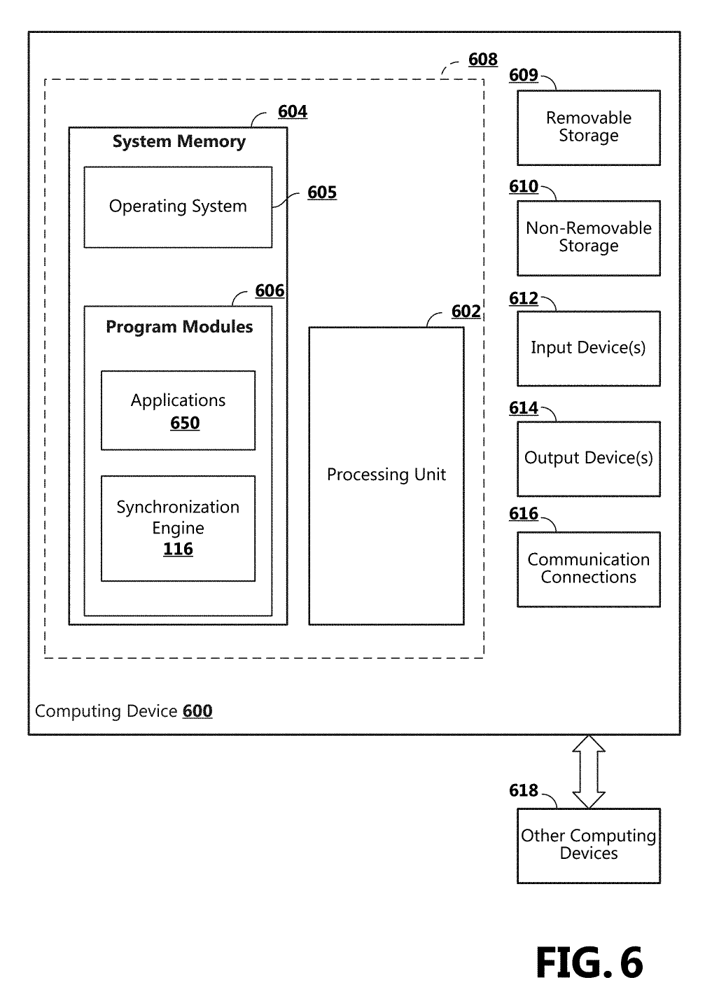

With reference now to FIG. 1, an example operating environment 100 including a synchronization engine 116 for transferring and synchronizing code between different source control systems is shown. The example operating environment 100 includes one or more client workstations 122 or client computing devices via which users 120 (e.g., software developers) can use to write and edit source code 110,130 used to build a particular software system, application, or software component. The client workstations 122 are operative to communicate over a network 134, which may include wired or wireless networking, with a source control system, such as source control system A 102 or source control system B 104, for managing different versions of source code files that are compiled together to create executables that are shipped to customers. The hardware of these computing devices is discussed in greater detail in regard to FIGS. 6, 7A, 7B, and 8.

A first source control system, source control system A 102, is illustrated as a centralized source control system, where a repository (source control system A repository 106) of source code A 110 is stored in a centralized location (e.g., on one or more servers). The terms “source control system A” and “centralized source control system” may be used interchangeably herein. Some examples of centralized source control systems include CONCURRENT VERSIONING SYSTEM (CVS), SUBVERSION (SVN), PERFORCE® by PERFORCE SOFTWARE INCORPORATED, and SOURCE DEPOT™ by MICROSOFT CORPORATION.

A second source control system, source control system B 104, is illustrated as a distributed source control system, where a plurality of developers 120 each clones a copy 126 of a repository (source control system B repository 108a-n, collectively 108) to his/her client workstation 122. For example, each copy 126 or clone includes all the metadata of the main source code B 130. The terms “source control system B” and “distributed source control system” may be used interchangeably herein. According to aspects, in the distributed source control system 104, developers on different client workstations 122 may share edited files directly, obviating the need to transfer files to a centralized location. However, in some examples, the distributed source control system 104 includes a centralized remote repository 128 operative to store a remote master or main branch of the source code 130. Some examples of distributed source control systems include MERCURIAL, GIT, and BAZAAR.

As should be appreciated, although source control system A 102 is described as a centralized source control system, and source control system B 104 is described as a distributed source control system, in other examples, source control system A can be a centralized source control system or a distributed source control system, and source control system B can be a centralized source control system or a distributed source control system.

The example operating environment 100 includes a synchronization engine 116, illustrative of a software module, system, or device operative to provide bridging technology that allows the first source control system A 102 to work in conjunction with the second source control system B 104. For example, developers 120 are enabled to use source control system B 104 as their source control while migrating tools associated with source control system A 102 to source control system B 104.

In some examples, the synchronization engine 116 enables software development teams to use tools associated with a centralized source control system (e.g., source control system A 102) and tools associated with a distributed source control system (e.g., source control system B 104). A developer 120 may use a client workstation 122 to check files in and out of a centralized source code repository 106 using tools for check-in and check-out associated with the centralized source control system 102. The same developer 120 may also use the client workstation 122 as part of the distributed source control system 104, for example, to work offline, share files with other client workstations 122 in the distributed source control system, and use tools associated with the distributed source control system. In some examples, tools associated with the distributed source control system 104 are used to make changes to source code (source code B 130) managed by the distributed source control system 104, such as to develop new software features or to fix bugs.

According to an aspect, the synchronization engine 116 is operative to obtain a replica of source code 110 or a subset 112 of source code 110 stored in source control system A repository 106. For example, the subset 112 may comprise source code associated with a specific project. The synchronization engine 116 is further operative to store the replicated source code in a first staging directory A 118a. In some examples, staging directory A 118a functions as a temporary source control system A client overlaid on a local source control system repository 108 associated with source control system B 104. Although the synchronization engine 116 and staging directories 118a,b are illustrated as executing on a server 114, in some examples, the synchronization engine or one or more of the staging directories may run in conjunction with source control system A 102. In other examples, the synchronization engine 116 or one or more of the staging directories 118a,b may run in conjunction with source control system B 104. In other examples, the synchronization engine 116 or one or more of the staging directories 118a,b may execute on one or more client workstations 122.

According to an aspect, the synchronization engine 116 is further operative to synchronize source code B 126 stored in the local source control system repository 108 associated with source control system B up to the replicated source control system A source code 110/112 based on a checkpoint. For example, the checkpoint is a moment in time at which the source code (source code A 110) is known to compile and work. In some examples, the checkpoint may be a latest checkpoint. In other examples, the checkpoint may be another specified checkpoint. The synchronization engine 116 is further operative to create a branch in the source control system B 104, wherein the synchronized changes between source code B 126 and the replicated source control system source A code 110/112 are added to the branch. Code branches are typically associated with a feature being developed or a bug fix being made, and may be shared with other developers 120.

The branch may be committed, wherein the changes in the branch are merged with a master branch of source code B 130. According to an aspect, the merge is based off a last commit that was migrated into source control system A 102 (as will be described in further detail below). Accordingly, if changes in the source code B 126 stored in the local source control system B repository 108 are newer than the replicated source control system A source code 110/112, the changes will be synchronized appropriately.

The synchronization engine 116 is further operative to transfer changes from the master branch of source code B 130 in the remote repository 128, and integrate the changes into staging directory B 118b that is associated with the local source control system B repository 108. Upon receiving an indication of a new commit on the remote master branch of source code B 130, a pull is invoked to replicate the remote master branch or a subset of the remote master branch, and store the replicated remote master branch in folder 132. The synchronization engine 116 is operative to create a client mapping on top of the replicated remote source code B master branch. According to an aspect, the folder 132 is configured to simulate a source control system A repository 106.

Further, the synchronization engine 116 is operative to determine whether there are any differences between the replicated remote source code B master branch in folder 132 and source code A 110/112. When differences between the files are identified, the synchronization engine 116 is further operative to generate a change set including the differences between the source code files, and store the change set in staging directory B 118b. According to an aspect, any changes in staging directory B 118b may be overwritten by changes made to the source code in the local source control system B repository 108. In some examples, the change set is checked into source control system A 102, where a validation loop validates that the change can build.

Upon validation that the change can build, the synchronization engine 116 is further operative to migrate changes from staging directory B 118b into the source control system A repository 106. According to an aspect, the synchronization engine 116 is operative to perform a baseless merge between files in staging directory B 118b (i.e., change set including the differences between the replica of the remote master branch of source code B 130 and files in the source control system A repository 106 (i.e., centralized source control system source code 110/112)). According to an aspect, when the code in staging directory B 118b is merged with the source control system A source code 110, a checkpoint is created.

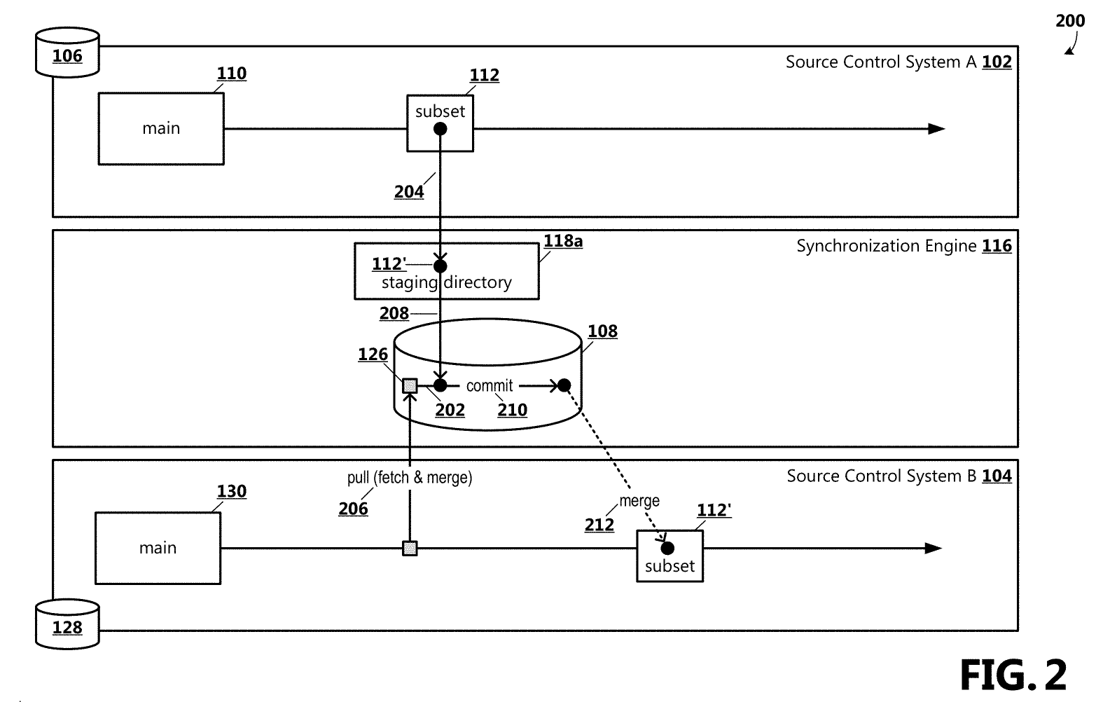

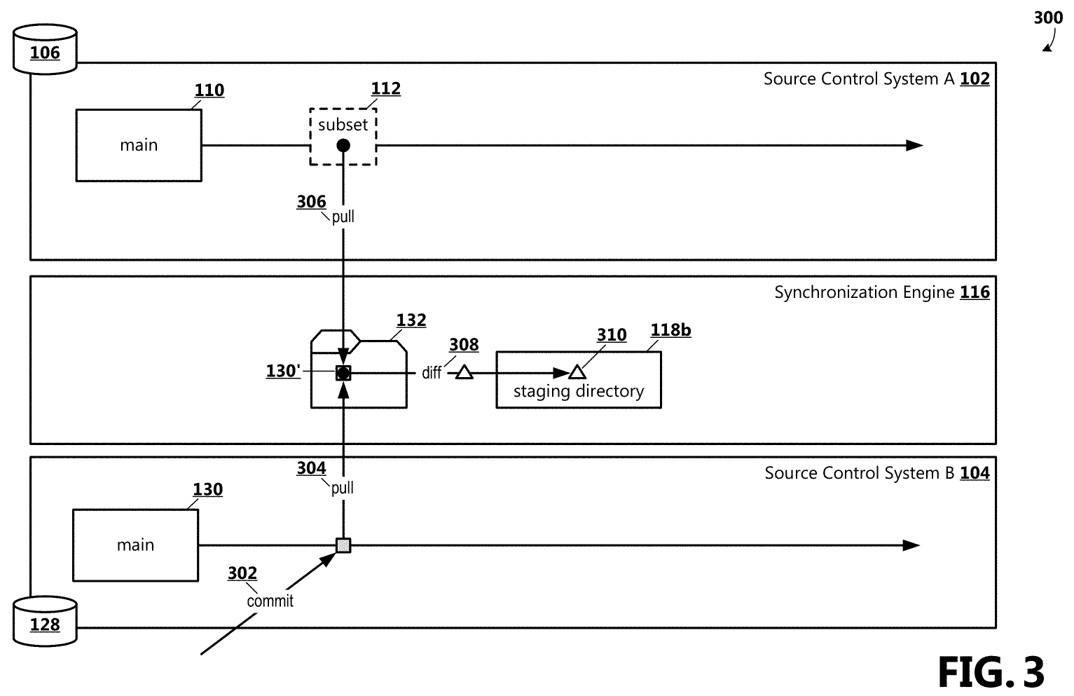

Having described an example operating environment 100 for providing transfer and synchronization of code between different source control systems, FIGS. 2-3 illustrate an example flow of data during a bridging process. As should be appreciated, the examples described with respect to FIGS. 2-3 illustrate an example of enabling use of a centralized source control system and a distributed source control system for developing software when transitioning from the centralized source control system to the distributed source control system. However, the synchronization engine 116 is also operative to provide transfer and synchronization of code between source control systems when transitioning from a distributed source control system to a centralized source control system, from one centralized source control system to another centralized source control system, or from one distributed source control system to another distributed source control system.

With reference now to FIG. 2, a data flow diagram showing an example forward bridging process 200 for migrating source code from a centralized source control system to a distributed source control system is illustrated. As illustrated, a main line of source code (source code A 110) is stored in source control system A repository 106 managed by source control system A 102, which is a centralized source control system. A replica 112′ of a subset 112 of source code A 110 is created and temporarily stored 204 in staging directory A 118a.

Also as illustrated, a remote master or main branch of source code (source code B 130 managed by source control system B 104) is stored in a remote repository 128. In some examples, a pull request is made, and changes to the remote master or main branch of source code B 130 are fetched and merged 206 with the local copy of source code B 126 stored in local distributed source control system repository 108 to ensure that the local master branch is up-to-date.

With reference still to FIG. 2, a branch 202 is created in the local distributed source control system repository 108, and the replica 112′ of the subset 112 of source code A 110 stored in staging directory A 118a is moved to the branch. The branch 202 is then committed 210 and merged with the local copy of source code B 126 stored in local distributed source control system repository 108. If there are any merge conflicts, the developer 120 may resolve the conflicts. Further, the branch 202 may then be pushed and merged 212 with the remote master or main branch of source code B 130 stored in the remote repository 128. According to an aspect, the merge is based off the last commit that was previously migrated to source control system A 102 from source control system B 104.

With reference now to FIG. 3, a data flow diagram is illustrated showing an example of a pull bridging process 300 for migrating source code from the second source control system to the first source control system. In the illustrated example, the synchronization engine 116 is used for migrating source code from the distributed source control system 104 to the centralized source control system 102. As illustrated in FIG. 3, a commit 302 on the remote repository 128 is detected by the synchronization engine 116, and a replica 130′ of the remote master or main branch of source code B 130 is created and integrated into folder 132, which is configured to simulate a centralized source control system repository. A client mapping of source code A 110 or a subset 112 of source code A is created and pulled 306 on top of the replica 130′ of the remote master or main branch of source code B 130 in the folder 132.

Referring still to FIG. 3, the synchronization engine 116 identifies differences 308 between the replicated remote source code B master branch in folder 132 and source code A 110/112, and a change set 310 including the differences between the source code files is generated and stored in staging directory B 118b. In some examples, the change set 310 is checked into source control system A 102, where a validation loop validates that the change can build.

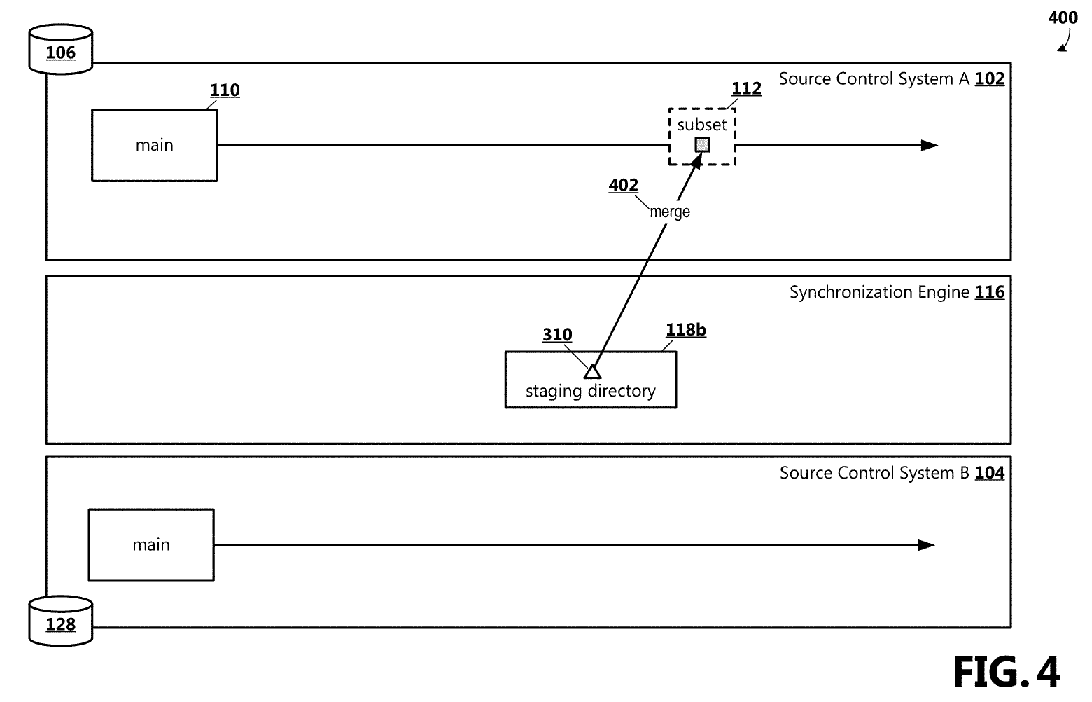

With reference now to FIG. 4, a data flow diagram is illustrated showing an example reverse bridging process 400 for merging source code from the second source control system to the main branch of source code in the first source control system. In the illustrated example, the source code is merged to the main branch of source code in a centralized source control system. As illustrated, a baseless merge 402 between the files in the change set 310 and the main branch of source code 110 is performed. Accordingly, the code changes that were transferred from the distributed source control system 104 are brought into the centralized source control system 102, and can go into a next checkpoint.

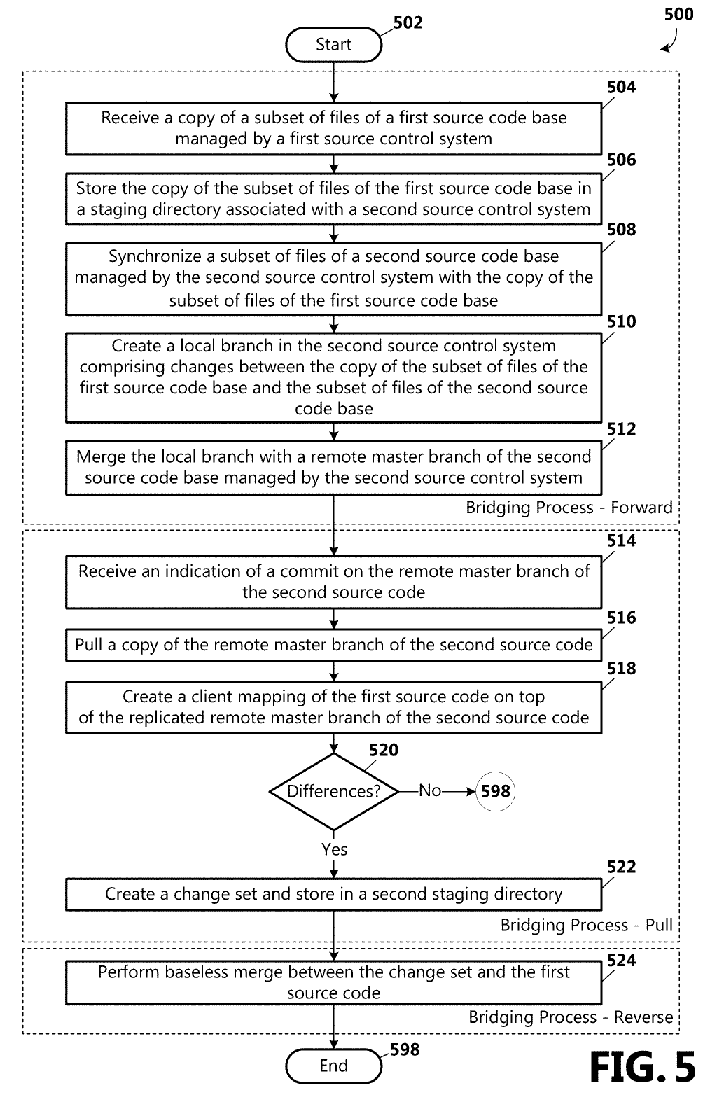

FIG. 5 is a flow chart showing general stages involved in an example method 500 for migrating source code between two source control systems. The method 500 starts at OPERATION 502, and proceeds to OPERATION 504, where a replica 112′ of a subset 112 of files of a first source code base 110 managed by a first source control system is received. In one example, the first source control system is the centralized source control system 102. For example, an organization may use the centralized source control system 102 as the main source code management tool in its development toolset for developing products. In another example, the first source control system may be the distributed source control system 104.

The method 500 proceeds to OPERATION 506, where the replica 112′ of the subset 112 of files of the first source code base 110 is stored in a first staging directory 118a associated with a second source control system. In one example, the second source control system is the distributed source control system 104. For example, a developer 120 or a team of developers may want to use the distributed source control system 104 for editing source code. In another example, the second source control system may be a centralized source control system 102.

The method 500 proceeds to OPERATION 508, where a subset of files of a second source code base managed by the second source control system is synchronized up to the replica 112′ of the subset 112 of files of the first source code base 110. According to an example, the second source code base is a local master branch 126 that is pulled from a remote main or master branch of the source code 130 into a local workspace or local repository 108 on a client workstation 122.

At OPERATION 510, a local branch 202 is created, and changes between the second source code base managed by the second source control system and the replica 112′ of the subset 112 of files of the first source code base 110 are added to the local branch.

The method 500 proceeds to OPERATION 512, where the local branch 202 is merged 212 with the remote main or master branch of the source code 130 stored in a remote repository 128. Accordingly, the subset 112 of files of the first source code base 110 is effectively migrated to the second source control system, where developers 120 are enabled to make changes to the subset using tools provided by the second source control system.

The method 500 proceeds to OPERATION 514, where an indication of a commit to the remote master branch of the second source code base 130 stored in a remote repository 128 is received. For example, a developer 120 may make a change to the second source code and commit the change to the remote master branch.

The method 500 proceeds to OPERATION 516, where a replica 130′ of the remote master branch is pulled 304 from the remote repository 128, and is temporarily stored into a folder 132. At OPERATION 528, the synchronization engine 116 is operative to create a client mapping of the first source code base 110/112 on top of the replicated remote master branch 130′ of the second source code base.

At DECISION OPERATION 520, a determination is made as to whether there are any differences between the replicated remote master branch 130′ of the second source code base in folder 132 and the first source code base 110/112. When a negative determination is made, the method 500 ends at OPERATION 598. When a positive determination is made, and differences 308 between the files are identified, and the method 500 proceeds to OPERATION 522, where a change set 310 is generated, wherein the change set includes the differences 308 between the source code files. The change set 310 is stored in staging directory B 118b, and checked into the first source control system, where a validation loop may then be run to validate that the change can be built.

The method 500 proceeds to OPERATION 524, where a baseless merge 402 is performed between files of the change set 310 and the first source code base 110 managed by a first source control system. The method 500 ends at OPERATION 598.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 6-8 and the associated descriptions provide a discussion of a variety of operating environments in which examples are practiced. However, the devices and systems illustrated and discussed with respect to FIGS. 6-8 are for purposes of example and illustration and are not limiting of a vast number of computing device configurations that are utilized for practicing aspects, described herein.

FIG. 6 is a block diagram illustrating physical components (i.e., hardware) of a computing device 600 with which examples of the present disclosure may be practiced. In a basic configuration, the computing device 600 includes at least one processing unit 602 and a system memory 604. According to an aspect, depending on the configuration and type of computing device, the system memory 604 comprises, but is not limited to, volatile storage (e.g., random access memory), non-volatile storage (e.g., read-only memory), flash memory, or any combination of such memories. According to an aspect, the system memory 604 includes an operating system 605 and one or more program modules 606 suitable for running software applications 650. According to an aspect, the system memory 604 includes the synchronization engine 116. The operating system 605, for example, is suitable for controlling the operation of the computing device 600. Furthermore, aspects are practiced in conjunction with a graphics library, other operating systems, or any other application program, and is not limited to any particular application or system. This basic configuration is illustrated in FIG. 6 by those components within a dashed line 608. According to an aspect, the computing device 600 has additional features or functionality. For example, according to an aspect, the computing device 600 includes additional data storage devices (removable and/or non-removable) such as, for example, magnetic disks, optical disks, or tape. Such additional storage is illustrated in FIG. 6 by a removable storage device 609 and a non-removable storage device 610.

As stated above, according to an aspect, a number of program modules and data files are stored in the system memory 604. While executing on the processing unit 602, the program modules 606 (e.g., synchronization engine 116) perform processes including, but not limited to, one or more of the stages of the method 500 illustrated in FIG. 5. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 6 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 600 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 600 has one or more input device(s) 612 such as a keyboard, a mouse, a pen, a sound input device, a touch input device, etc. The output device(s) 614 such as a display, speakers, a printer, etc. are also included according to an aspect. The aforementioned devices are examples and others may be used. According to an aspect, the computing device 600 includes one or more communication connections 616 allowing communications with other computing devices 618. Examples of suitable communication connections 616 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. According to an aspect, any such computer storage media is part of the computing device 600. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

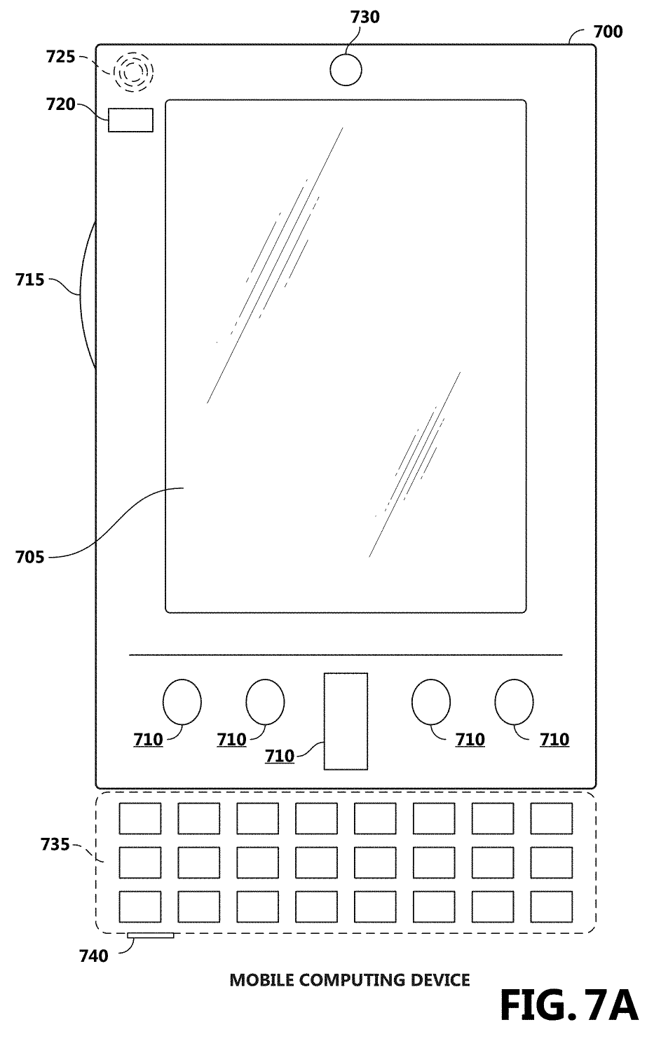

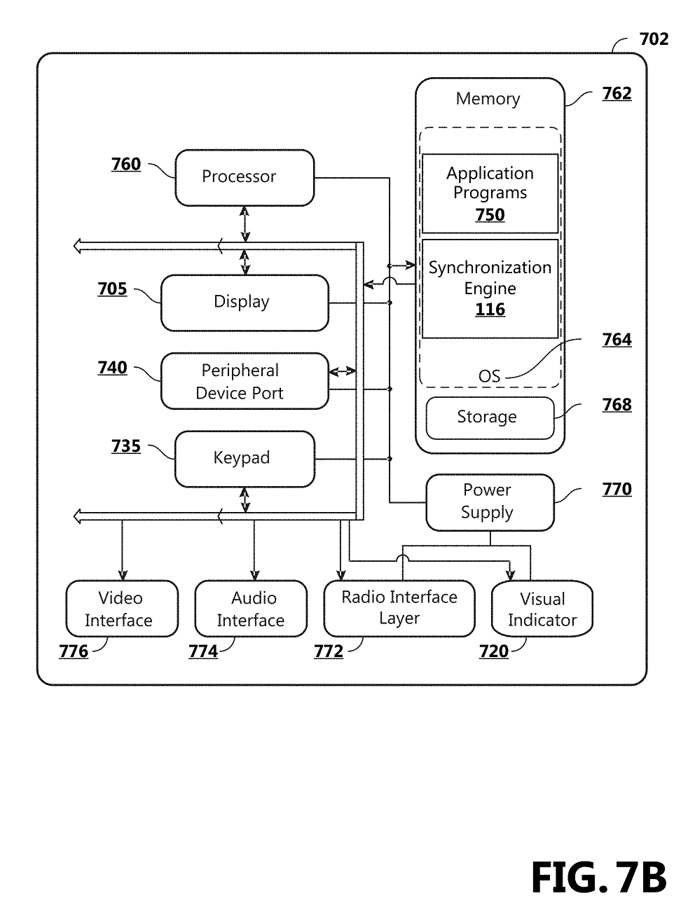

FIGS. 7A and 7B illustrate a mobile computing device 700, for example, a mobile telephone, a smart phone, a tablet personal computer, a laptop computer, and the like, with which aspects may be practiced. With reference to FIG. 7A, an example of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. According to an aspect, the display 705 of the mobile computing device 700 functions as an input device (e.g., a touch screen display). If included, an optional side input element 715 allows further user input. According to an aspect, the side input element 715 is a rotary switch, a button, or any other type of manual input element. In alternative examples, mobile computing device 700 incorporates more or less input elements. For example, the display 705 may not be a touch screen in some examples. In alternative examples, the mobile computing device 700 is a portable phone system, such as a cellular phone. According to an aspect, the mobile computing device 700 includes an optional keypad 735. According to an aspect, the optional keypad 735 is a physical keypad. According to another aspect, the optional keypad 735 is a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some examples, the mobile computing device 700 incorporates a vibration transducer for providing the user with tactile feedback. In yet another example, the mobile computing device 700 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 700 incorporates peripheral device port 740, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one example of a mobile computing device. That is, the mobile computing device 700 incorporates a system (i.e., an architecture) 702 to implement some examples. In one example, the system 702 is implemented as a “smart phone” capable of running one or more applications (e.g., browser, e-mail, calendaring, contact managers, messaging clients, games, and media clients/players). In some examples, the system 702 is integrated as a computing device, such as an integrated personal digital assistant (PDA) and wireless phone.

According to an aspect, one or more application programs 750 are loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. According to an aspect, the synchronization engine 116 is loaded into memory 762. The system 702 also includes a non-volatile storage area 768 within the memory 762. The non-volatile storage area 768 is used to store persistent information that should not be lost if the system 702 is powered down. The application programs 750 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

According to an aspect, the system 702 has a power supply 770, which is implemented as one or more batteries. According to an aspect, the power supply 770 further includes an external power source, such as an AC adapter or a powered docking cradle that supplements or recharges the batteries.

According to an aspect, the system 702 includes a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 750 via the operating system 764, and vice versa.

According to an aspect, the visual indicator 720 is used to provide visual notifications and/or an audio interface 774 is used for producing audible notifications via the audio transducer 725. In the illustrated example, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. According to an aspect, the system 702 further includes a video interface 776 that enables an operation of an on-board camera 730 to record still images, video stream, and the like.

According to an aspect, a mobile computing device 700 implementing the system 702 has additional features or functionality. For example, the mobile computing device 700 includes additional data storage devices (removable and/or non-removable) such as, magnetic disks, optical disks, or tape. Such additional storage is illustrated in FIG. 7B by the non-volatile storage area 768.

According to an aspect, data/information generated or captured by the mobile computing device 700 and stored via the system 702 is stored locally on the mobile computing device 700, as described above. According to another aspect, the data is stored on any number of storage media that is accessible by the device via the radio 772 or via a wired connection between the mobile computing device 700 and a separate computing device associated with the mobile computing device 700, for example, a server computer in a distributed computing network, such as the Internet. As should be appreciated such data/information is accessible via the mobile computing device 700 via the radio 772 or via a distributed computing network. Similarly, according to an aspect, such data/information is readily transferred between computing devices for storage and use according to well-known data/information transfer and storage means, including electronic mail and collaborative data/information sharing systems.

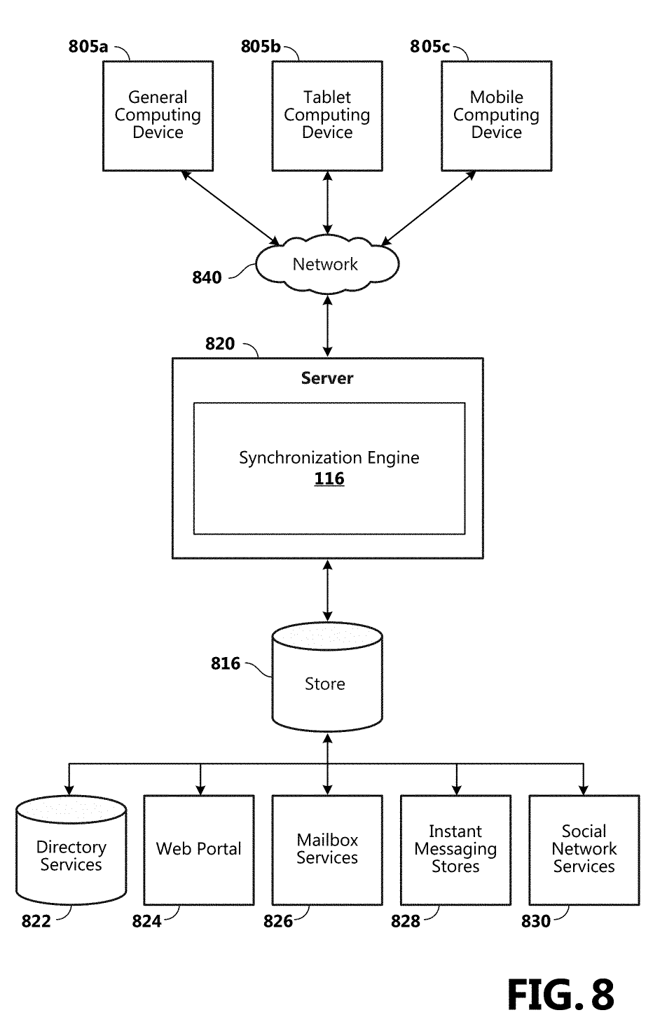

FIG. 8 illustrates one example of the architecture of a system for synchronizing a code base between source control systems as described above. Content developed, interacted with, or edited in association with the synchronization engine 116 is enabled to be stored in different communication channels or other storage types. For example, various documents may be stored using a directory service 822, a web portal 824, a mailbox service 826, an instant messaging store 828, or a social networking site 830. The synchronization engine 116 is operative to use any of these types of systems or the like for synchronizing a code base between source control systems, as described herein. According to an aspect, a server 820 provides the synchronization engine 116 to clients 805a,b,c. As one example, the server 820 is a web server providing the synchronization engine 116 over the web. The server 820 provides the synchronization engine 116 over the web to clients 805 through a network 840. By way of example, the client computing device is implemented and embodied in a personal computer 805a, a tablet computing device 805b or a mobile computing device 805c (e.g., a smart phone), or other computing device. Any of these examples of the client computing device are operable to obtain content from the store 816.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A computer-implemented method of transitioning source code between two source control systems, comprising:
receiving a replica of files of a first source code base managed by a first source control system at a specific checkpoint;
temporarily storing the replica of files of the first source code base in a first staging directory;
synchronizing files of a second source code base managed by a second source control system up to the replica of files of the first source code base;
creating a branch in the second source control system comprising a change set between the replica of files of the first source code base and the files of the second source code base; and
merging the branch to a main branch of the second source code managed by the second source control system.

2. The method of claim 1, wherein receiving the replica of files of the first source code base comprises receiving a replica of a subset of files of a main branch of the first source code base.

3. The method of claim 1, wherein merging the branch to the main branch of the second source code managed by the second source control system comprises merging the branch to the main branch at a last previous commit migrated to the first source control system from the second source control system.

4. The method of claim 1, wherein receiving the replica of files of the first source code base managed by the first source control system at the specific checkpoint comprises receiving the replica of files at a state of a build of the first source code base at which the first source code base is known to compile and pass verification.

5. The method of claim 1, wherein:
receiving the replica of files of the first source code base managed by the first source control system comprises receiving the replica of files of the first source code base managed by a centralized source control system; and
synchronizing files of the second source code base managed by the second source control system comprises synchronizing files of the second source code base managed by a distributed source control system.

6. The method of claim 1, further comprising:
receiving an indication of changes made to the main branch of the second source code managed by the second source control system;
receiving a replica of files of the main branch of the second source code;
temporarily storing the replica of files of the main branch of the second source code in a folder;
synchronizing files of the first source code base with the replica of files of the second source code base;
identifying code changes between the files of the first source code base and the replica of files of the second source code base; and
temporarily storing a change set comprising the code changes in a staging directory associated with the first source control system.

7. The method of claim 6, further comprising checking the change set comprising the code changes into the first source control system for validation of the code changes.

8. The method of claim 6, further comprising merging the change set comprising the code changes to a main branch of the first source code base managed by the first source control system.

9. The method of claim 8, wherein merging the change set to the main branch of the first source code base is performed in response to receiving an indication of a passing validation of the code changes.

10. A system for transitioning source code between two source control systems, the computing device comprising:
at least one processing device; and
at least one computer readable data storage device storing instructions that, when executed by the at least one processing device, provide a synchronization engine, the synchronization engine operative to:
receive a replica of files of a first source code base managed by a first source control system at a specific checkpoint;
temporarily store the replica of files of the first source code base in a first staging directory;
synchronize files of a second source code base managed by a second source control system up to the replica of files of the first source code base;
create a branch in the second source control system comprising a change set between the replica of files of the first source code base and the files of the second source code base; and
merge the branch to a main branch of the second source code managed by the second source control system.

11. The system of claim 10, wherein in merging the branch to the main branch of the second source code managed by the second source control system, the synchronization engine is operative to merge the branch to the main branch at a last previous commit migrated to the first source control system from the second source control system.

12. The system of claim 10, wherein the checkpoint is a state of a build of the first source code base at which the first source code base is known to compile and pass verification.

13. The system of claim 10, wherein the first source control system is a centralized source control system.

14. The system of claim 10, wherein the second source control system is a distributed source control system.

15. The system of claim 10, wherein the synchronization engine is further operative to:
receive an indication of changes made to the main branch of the second source code managed by the second source control system;
receive a replica of files of the main branch of the second source code;
temporarily store the replica of files of the main branch of the second source code in a folder;
synchronize files of the first source code base up with the replica of files of the second source code base;
identify code changes between the files of the first source code base and the replica of files of the second source code base; and
temporarily store a change set comprising the code changes in a staging directory associated with the first source control system.

16. The system of claim 15, wherein the synchronization engine is further operative to check the change set comprising the code changes into the first source control system for validation of the code changes.

17. The system of claim 15, wherein the synchronization engine is further operative to merge the change set comprising the code changes to a main branch of the first source code base managed by the first source control system.

18. The system of claim 17, wherein prior to merging the change set to the main branch of the first source code base, the synchronization engine is operative to receive an indication of a passing validation of the code changes.

19. A computer readable storage device including computer readable instructions, which when executed by a processing unit is operative to:
receive a replica of files of a first source code base managed by a first source control system at a specific checkpoint;
temporarily store the replica of files of the first source code base in a first staging directory;
synchronize files of a second source code base managed by a second source control system up to the replica of files of the first source code base;
create a branch in the second source control system comprising a change set between the replica of files of the first source code base and the files of the second source code base;
merge the branch to a main branch of the second source code managed by the second source control system at a last previous commit migrated to the first source control system from the second source control system;
receive an indication of changes made to the main branch of the second source code managed by the second source control system;
receive a replica of files of the main branch of the second source code;
temporarily store the replica of files of the main branch of the second source code in a folder;
synchronize files of the first source code base up with the replica of files of the second source code base;
identify code changes between the files of the first source code base and the replica of files of the second source code base;
temporarily store a change set comprising the code changes in a staging directory associated with the first source control system; and
merge the change set comprising the code changes to a main branch of the first source code base managed by the first source control system.

20. The computer readable storage device of claim 19, wherein:
the first source control system is a centralized source control system; and
the second source control system is a distributed source control system.
